(19) United States
(12) Patent Application Publication
(10) Pub. No.: US 2012/0247508 A1
(43) Pub. Date: Oct. 4, 2012

(54) BRUSH AND METHOD FOR CLEANING A SUBSTRATE AND SCRUBBER EMPLOYING THE SAME

(75) Inventors: Gun-Ig Jeung, Hwaseong-si (KR); Ji-Chul Yang, Seoul (KR); Jae-Phil Boo, Seongnam-si (KR)

(73) Assignee: SAMSUNG ELECTRONICS CO., LTD., Suwon-si (KR)

(21) Appl. No.: 13/411,994

(22) Filed: Mar. 5, 2012

(30) Foreign Application Priority Data
Mar. 28, 2011 (KR) 10-2011-0027510

(51) Int. Cl. A46B 5/00; B08B 1/00

(52) U.S. Cl. 134/6; 15/207.2

(57) ABSTRACT

A brush includes a roller body, a first brush layer and a second brush layer. The first brush layer covers an outer surface of the roller body. The second brush layer is on the first brush layer, and is thinner than the first brush layer. The rate of pore formation of the second layer is lower than the rate of pore formation of the first brush layer.

### CROSS-REFERENCE TO RELATED APPLICATION

This application claims priority under 35 USC §119 to Korean Patent Application No. 10-2011-0027510 filed on Mar. 28, 2011, in the Korean Intellectual Property Office (KIPO), the entire contents of which is incorporated herein by reference.

### BACKGROUND

1. Field

The inventive concept relates to a brush for cleaning a substrate, a method of using such a brush, and a scrubber that includes such a brush. More particularly, the inventive concept relates to a brush for cleaning a substrate after a polishing process, a method of using such a brush, and a scrubber that includes such a brush.

2. Description of the Related Art

Chemical-mechanical polishing (CMP) is a process used, for example, for planarizing a film on, or otherwise removing unwanted materials from, a substrate such as a semiconductor wafer before processing the wafer. CMP may entail the introduction of a polishing slurry onto the surface of the film as the wafer is being mechanically polished against a rotating polishing pad. Such a process entails supplying a slurry that includes a polishing chemical and abradant to the substrate, then applying pressure to remove a portion of the substrate, thereby polishing the substrate. The removed portion may include a layer structure of the substrate, for example. Unfortunately, the removed materials and/or the remnant of the slurry may be adsorbed onto a surface of the substrate, thereby necessitating a subsequent cleaning process. A brush, preferably a highly efficient and long-lasting one, may be employed in such a cleaning process.

### SUMMARY

Exemplary embodiments of the inventive concept may provide a brush for cleaning a substrate having a high cleaning efficiency and a long life.

Exemplary embodiments of the inventive concept may provide a scrubber including a brush for cleaning a substrate having a high cleaning efficiency and a long life.

According to exemplary embodiments of the inventive concept, there is provided a brush for cleaning a substrate. The brush includes a roller body, a first brush layer and a second brush layer. The first brush layer covers an outer surface of the roller body. The second brush layer is on the first brush layer, and is thinner than the first brush layer. The rate of pore formation of the second layer is lower than the rate of pore formation of the first brush layer.

In exemplary embodiments of the inventive concept, the first and second brush layers may have protrusions.

In exemplary embodiments of the inventive concept, the first brush layer may further include cylindrical portions between the protrusions, and the second brush layer may cover the first brush layer along the protrusions and the cylindrical portions thereof.

In exemplary embodiments of the inventive concept, the protrusions may be arranged regularly.

In exemplary embodiments of the inventive concept, the second brush layer may include a plurality of pores, and a rate of pore formation of the second brush layer may be from about 10% to about 20%.

In exemplary embodiments of the inventive concept, the second brush layer may have a thickness of from about 10 μm to about 20 μm.

In exemplary embodiments of the inventive concept, the first brush layer may include a plurality of pores, and a rate of pore formation of the first brush layer may be from about 80% to about 90%.

In exemplary embodiments of the inventive concept, the first and second brush layers may include a porous material of polyvinyl acetyl series.

In exemplary embodiments of the inventive concept, the number of the pores of the first brush layer may be larger than that of the second brush layer.

According to exemplary embodiments of the inventive concept, there is provided a scrubber for cleaning a substrate. The scrubber includes a first rotating roller, at least one brush and a second rotating roller for rotating the substrate. The brush is coupled to the first rotating roller and makes contact with the substrate. The brush includes a roller body, a first brush layer and a second brush layer. The first brush layer covers an outer surface of the roller body. The second brush layer is on the first brush layer, and is thinner than the first brush layer. The rate of pore formation of the second layer is lower than the rate of pore formation of the first brush layer.

In exemplary embodiments of the inventive concept, one brush may make contact with a first surface of the substrate and another brush may make contact with a second surface of the substrate.

In exemplary embodiments of the inventive concept, the second brush layer may include a plurality of pores, and a rate of pore formation of the second brush layer may be from about 10% to about 20%.

In exemplary embodiments of the inventive concept, the second brush layer may have a thickness of from about 10 μm to about 20 μm.

In exemplary embodiments of the inventive concept, the first brush layer may include a plurality of pores, and a rate of pore formation of the first brush layer may be from about 80% to about 90%.

In exemplary embodiments of the inventive concept, the first and second brush layers may include a porous material of polyvinyl acetyl series.

According to exemplary embodiments of the inventive concept, a brush for cleaning a wafer having a long life and a high cleaning efficiency may be provided. Additionally, the substrate may not be contaminated during the cleaning process. Accordingly, the yield rate of the semiconductor device may be enhanced.

According to exemplary embodiments of the inventive concept, a method of scrubbing a semiconductor wafer with a brush may be provided. In such exemplary embodiments a brush may have first and second layers, the second layer being thinner than the first, the second layer having a lower pore density than the first, and the second brush layer may contact the semiconductor wafer during scrubbing. The second brush layer may be from about 10 μm to about 20 μm thick and have a pore density of from about 10% to about 20%. The first brush layer may have a pore density of from about 80% to about 90%. The first and second layers of the brush may include a porous material of a polyvinyl acetyl series, for example, and may be generally cylindrical, with protrusions projecting therefrom. Such wafer-scrubbing may take place after wafer planarization, for example.

### BRIEF DESCRIPTION OF THE DRAWINGS

Exemplary embodiments of the inventive concept will be more clearly understood from the following detailed description taken in conjunction with the accompanying drawings. FIGS. 1-6 represent non-limiting, exemplary embodiments of the inventive concept as described herein.

FIG. 1 is a front view illustrating a scrubber in accordance with exemplary embodiments of the inventive concept;

FIG. 2 is a side view of the scrubber in FIG. 1;

FIG. 3 is a cross-sectional view illustrating a brush in accordance with exemplary embodiments of the inventive concept;

FIG. 4 is an enlarged perspective view of a protrusion of a brush layer in accordance with exemplary embodiments of the inventive concept;

FIG. 5A is a photo of a top surface of the protrusion in FIG. 4, and FIG. 5B is a photo of the cross-section of the protrusion in FIG. 4 taken along the line I-I′; and

FIG. 6 is a graph illustrating yield drop rates of Example and Comparative Example.

It should be noted that these figures are intended to illustrate the general characteristics of methods, structure and/or materials utilized in certain exemplary embodiments of the inventive concept and to supplement the written description provided below. These drawings are not, however, to scale and may not precisely reflect the structural or performance characteristics of any given embodiment, and should not be interpreted as defining or limiting the range of values or properties encompassed by exemplary embodiments of the inventive concept. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Exemplary embodiments of the inventive concept will now be described more fully with reference to the accompanying drawings, in which exemplary embodiments of the inventive concept are shown. Exemplary embodiments of the inventive concept may, however, be embodied in many different forms and should not be construed as limited to the embodiments set forth herein; rather, these exemplary embodiments of the inventive concept are provided so that this description will be thorough and complete, and will fully convey the concept of exemplary embodiments of the inventive concept to those of ordinary skill in the art. In the drawings, the thicknesses of layers and regions are exaggerated for clarity. Like reference numerals in the drawings denote like elements, and thus their description will be omitted.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated, for example, 90 degrees or at other orientations) and the spatially relative descriptors used herein interpreted accordingly.

The terminology used herein is for the purpose of describing particular exemplary embodiments of the inventive concept only and is not intended to be limiting of the inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Exemplary embodiments of the inventive concept are described herein with reference to cross-sectional illustrations that are schematic illustrations of idealized exemplary embodiments of the inventive concept (and intermediate structures). As such, variations from the shapes of the illustrations as a result, for example, of manufacturing techniques and/or tolerances, are to be expected. Thus, exemplary embodiments of the inventive concept should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

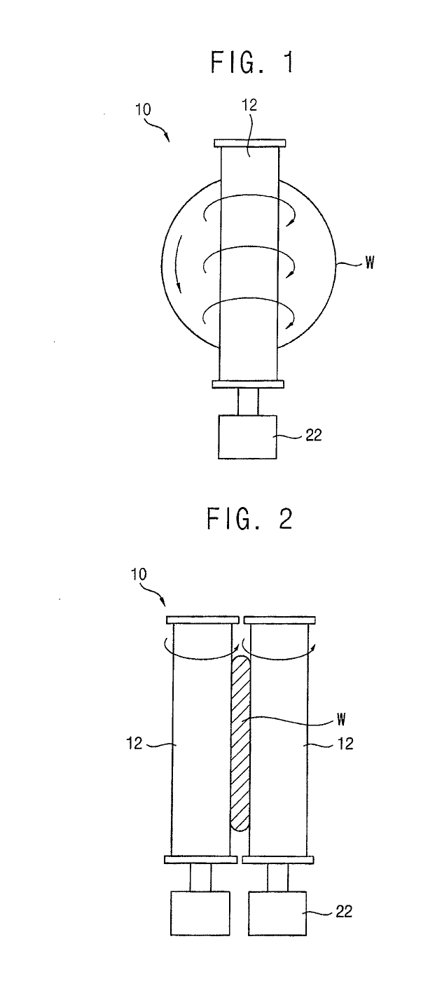

FIG. 1 is a front view illustrating a scrubber in accordance with exemplary embodiments of the inventive concept, and FIG. 2 is a side view of the scrubber in FIG. 1.

Referring to FIGS. 1 and 2, a scrubber 10 may clean a substrate, such as a wafer W, for example, after a chemical mechanical polishing (CMP) process. Such a chemical CMP process may be employed to remove unwanted materials from wafer W, to polish the wafer W, to planarize a film, or to otherwise prepare the wafer W for subsequent process steps, such as etching or photolithography, for example. The CMP process may entail, for example, supplying a slurry that includes a polishing chemical and abradant to the substrate, then applying pressure, via a rotating polishing pad, for example, to remove a portion of the substrate, thereby polishing the wafer W. Unfortunately, the removed materials and/or the remnant of the slurry may be adsorbed onto a surface of the substrate, thereby necessitating a subsequent cleaning process. In this exemplary embodiment of the inventive concept, the scrubber 10 may perform such a cleaning process. The scrubber 10 may include a first roller, 22 and a brush 12 coupled to the first roller 22.

In operation, the brush 12 may clean the wafer W by contacting the wafer W while being rotated by the roller 22. In exemplary embodiments of the inventive concept, the scrubber 10 may include two brushes 12. One brush 12 may make contact with, and clean, a first surface of the wafer W while the other brush 12 may make contact with, and clean, a second surface of the wafer W. The scrubber 10 may also include a roller (not shown) for rotating the wafer W. With the wafer W rotating, and the brushes 12 rotating while in contact with the wafer W, an adsorbate on the surfaces of the wafer W may be removed from the surface of wafer W. The adsorbate removed in this cleaning process may, for example, be CMP materials removed from the wafer W and/or the remnant of a CMP slurry,

During a cleaning process, the brush 12 makes direct, pressurized, contact with the surface of the wafer W to remove the adsorbate. Over time, the brush 12 could, potentially, be abraded as a result, of such pressurized contact. Additionally, adsorbate and/or particles adsorbed to pores of the brush 12 could, potentially, remain in the pores, only to be released and adsorbed to the wafer W again, thereby undermining the cleaning process. A brush 12 in accordance with exemplary embodiments of the inventive concept is substantially unsusceptible to abrading and, because it is not prone to adsorbing and re-releasing CMP materials and/or slurry, is also highly efficient.

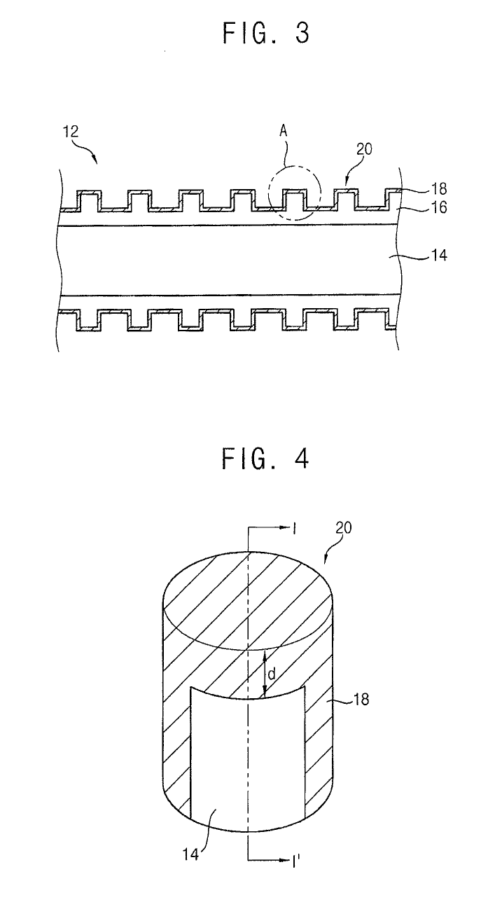

FIG. 3 is a cross-sectional view illustrating a brush in accordance with exemplary embodiments of the inventive concept. Brush 12 may include a roller body 14 and first and second brush layers 16 and 18, respectively. Roller body 14 may be generally cylindrical, and the first and second brush layers 16 and 18 may be sequentially stacked, or layered, on an outer surface of roller body 14. First and second brush layers 16 and 18 may include a porous material that is elastic when wet with water, such as a porous material of polyvinyl acetyl series, for example. The porous material of first and second layers 16 and 18, a material of the polyvinyl acetyl series, for example, may be relatively hard in a dry state and relatively soft and elastic in a wet state. Such material may also exhibit good absorptiveness and water retention, for example.

In an exemplary embodiment in accordance with the inventive concept first brush layer 16 may cover the outer surface of the roller body 14 and second brush layer 18 may cover first brush layer 16. Additionally, in this exemplary embodiment, second brush layer 18 may be thinner than first layer 16. An outer surface of second brush layer 18 may make contact with and clean the wafer W. As used herein, the term, “rate of pore formation,” refers to the percentage of a surface that is dedicated to pore openings; the term “pore density” will also be used herein. If, for example, twenty percent of the surface is dedicated to pore openings, the surface is said to have a rate of pore formation of twenty percent. With ninety percent of the surface dedicated to pore openings, the surface would be referred to as having a rate of pore formation of ninety percent. In exemplary embodiments of the inventive concept, the respective volume rate of pore formation for each layer 16 and 18 may be substantially equal to the rate of pore formation at any surface, or cross-section, of the respective layer 16 and 18. In an exemplary embodiment of the inventive concept, second brush layer 18 may have a rate of pore formation lower than that of the first brush layer 16. That is, second bush layer 18 may have fewer, and/or, smaller pores than first layer 16.

In exemplary embodiments of the inventive concept, first brush layer 16 may have a plurality of protrusions 20 at an outer surface thereof. Second brush layer 18 may cover the outer surface of first brush layer 16 along the protrusions, as well as cylindrical-surface portions of the first brush layer 16 between the protrusions. Thus, the second brush layer 18 may have also a plurality of protrusions 20 and cylindrical portions. Hereinafter, the protrusions of both of the first and second brush layers 16 and 18 may be referred to as protrusions 20.

In exemplary embodiments of the inventive concept, the protrusions 20 may be arranged regularly. The protrusions 20 may have, for example, a cylindrical shape, a square pillar shape, a spherical shape, a hemispherical shape, an elliptic cylindrical shape, or a diamond shape, for example. In the exemplary embodiment of FIG. 3, the protrusions 20 may have a cylindrical shape. The wafer W may be cleaned more efficiently due to the protrusions 20.

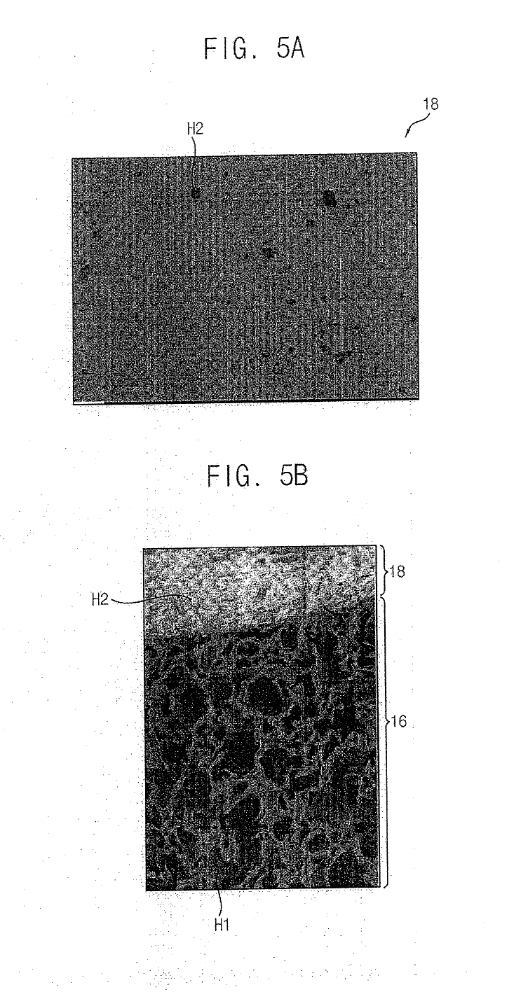

FIG. 4 is an enlarged perspective view of an exemplary cylindrical embodiment of a brush protrusion 20 in accordance with the inventive concept. In particular, this view is an enlarged perspective view of region A of brush 12 in FIG. 3. FIG. 5A is a photo of a top surface of the protrusion in FIG. 4 and, as such, is a photo of second layer 18, FIG. 5B is a photo of the cross-section of the protrusion in FIG. 4 taken along the line I-I,′ which reveals segments of first and second layers 16,18.

As shown in FIG. 5A, the second brush layer 18 may include a plurality of pores H2. The pores may be of substantially uniform size and distribution, or may be irregular in size and distribution. In an exemplary embodiment in accordance with the inventive concept, the rate of pore formation, that is, the percentage of the layer 18 that is occupied by pores (rather than brush material), may be from about 10% to about 20%. In operation, then, about 80% to 90% of the second brush layer 18 may be solid (but elastic), and capable of making contact with the wafer W during a scrubbing operation.

A relatively low rate of pore formation (for example, from about 10% to 20%) allows for a substantial amount of contact between brush material of the second brush layer 18 and a wafer W being scrubbed, facilitating effective, efficient removal of unwanted materials, such as adsorbates or particles removed from a wafer W during CMP.

Because more brush material is available in exemplary embodiments having low rates of pore formation, those areas of the brush 12 adjacent pores are less likely to be torn and, as a result, a relatively low rate of pore formation in the second brush layer 18 acts to reduce the deformation of the surface of the brush 12 during scrubbing and to extend the useful “life” of a bush 12. A low rate of pore formation in the second brush layer 18 may also act to reduce contamination of the brush 12 by CMP-related particles or adsorbates.

In an exemplary embodiment in accordance with claimed subject matter, a brush 12 may include a second brush layer 18 having a thickness of from about 10 μm to about 20 μm. With a thickness greater than about 20 μm a brush 12 may be too rigid and may tend to scratch a wafer during scrubbing. With a layer 18 having a thickness less than about 10 μm the brush 12 may not clean as effectively or last as long.

In an exemplary embodiment in accordance with the inventive concept, first brush layer 16 may include a plurality of pores H1. The pores may be of substantially uniform size and distribution, or may be irregular in size and distribution. The rate of pore formation, that is, the percentage of the layer 16 that is occupied by pores (rather than brush material), may be from about 80% to about 90%. In operation, then, about 10% to 20% of the second brush layer 18 may be solid (but elastic). As a result, first brush layer 16 may absorb a substantial quantity of cleansing fluid, such as purified water. With a significant volume of first layer 16 occupied by water, brush 12 may be more effective at cleaning and may exhibit significant flexibility.

In an exemplary embodiment in accordance with the inventive concept, the number of pores H1 in first brush layer 16 may be greater than the number of pores H2 in second brush layer 18. As previously indicated, the pores H1 and H2 may be of regular or irregular size.

The second brush layer 18 may have a uniform or non-uniform thickness. The thickness of the second brush layer 18 may be tailored within a range of from about 10 μm to about 20 μm, according to the type of chemicals used in the brushing process, for example. When a chemical having good adsorptiveness is used in the brushing process, second brush layer 18 may be relatively thick; a chemical having poor adsorptiveness may be matched with a relatively thin (that is, about 10 μm) layer 18.

In an exemplary embodiment in accordance with the inventive concept, a brush 12 including first and second layers 16,18 may be formed by preparing a solution using polyvinyl alcohol of a saponification value equal to at least about 80% at an average polymerization degree of about 300 to about 2,000. A cross-linking agent, such as an, aldehyde is then added to the solution, along with, a catalyst, such as, mineral acids, and a pore generator, or pore-forming agent, such as, starch. After these additions, the solution is cured to form an elastic sponge-like brush having first 16 and second 18 layers. The size and rate of pore formation of the first pores H1 of the first brush layer 16 may be controlled by process conditions, such as temperature and the contents of the solution, for example. In an exemplary embodiment in accordance with the principles of the inventive concept, the rate of pore formation in the first layer may be controlled to yield a relatively high rate of pore formation, for example, from about 80% to about 90%. Protrusions may be formed on first brush layer 16.

Once formed, the outer surface of first brush layer 16 may be treated to form a second brush layer 18 having a lower pore formation rate than that of the first layer 16: from about 10% to about 20%, for example. In an exemplary embodiment in accordance with the principles of the inventive concept, second brush layer 18 may be formed to a thickness of from about 10 μm to about 20 μm, for example. Alternatively, second brush layer 18 may be coated on first brush layer 16.

Once formed, a brush 12 in accordance with the principles of the inventive concept may be used to clean a wafer W after the wafer W has undergone CMP, for example. A brush 12 may be used to remove residual slurry or other residue from the CMP process, in preparation for processing steps, such as etching or photolithography, for example.

Referring, again, to FIGS. 1 and 2, brush 12 may be infused with purified water, for example, and roller body 14 of brush 12 may be coupled to and rotated by the rotating roller 22. The wafer W may be also rotated. Protrusions 20 of the second brush layer 18 may make contact with, and apply pressure to, surfaces of the wafer W while the brush 12 rotates. With protrusions 20 alternately making contact with and not making contact with a surface of the wafer W, residue may be transported from the wafer surface, thereby effectively cleaning a surface of the wafer W.

In an exemplary embodiment, with a second layer 18 of a brush 12 exhibiting a rate of pore formation of from about 10% to about 20%, 80% to 90% of the brush surface is material (rather than open pores) that may remove particles and adsorbates from a surface of a wafer W. With a first brush layer 16 in an exemplary embodiment having a relatively high rate of pore formation of from about 80 to about 90% sufficient pure water may be introduced to first brush layer 16 to ensure high elasticity and to aid in flushing residue from wafer W.

An experiment was conducted to compare the effectiveness of a brush in accordance with the inventive concept to the effectiveness of a conventional brush. In the experiment, a conventional brush was used to scrub a wafer after CMP and a brush in accordance with the inventive concept was used to scrub a wafer after CMP. In this exemplary embodiment, the brush in accordance with the principles of the inventive concept was a two-layer brush exhibiting a pore formation rate of about 80% in its first layer. The second, outside, layer of the brush was about 20 μm thick and exhibited a rate of pore formation of about 20%. The conventional brush, used for comparison, was a single-layer brush exhibiting a rate of pore formation of about 74%. After scrubbing, the degree of contamination of each wafer was measured and an associated yield drop rate was calculated for each wafer.

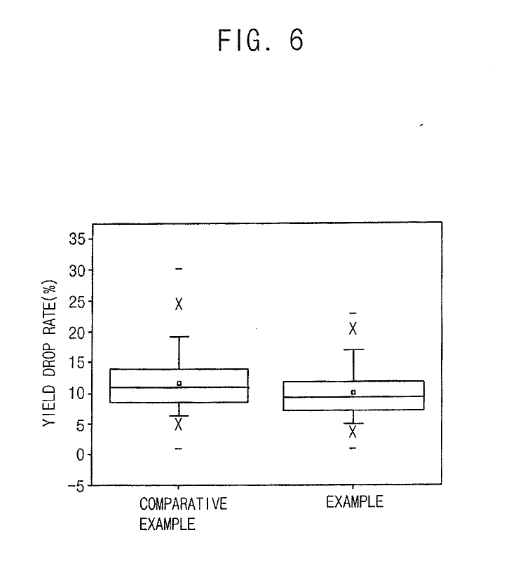

FIG. 6 is a graph illustrating yield drop rates associated with the wafer scrubbed using a brush in accordance with the principles of the inventive concept (labeled “Example” in the graph) and with a wafer scrubbed using a conventional brush (labeled “Comparative Example” in the graph.

As shown in FIG. 6, the yield drop rate associated with the use of a brush in accordance with principles of the inventive concept (“Example” in FIG. 6) was about 10%. On the other hand, the yield drop rate associated with the use of a conventional brush (“Comparative Example” of FIG. 6) was about 11.6%. That is, the yield drop rate was reduced by 1.6% beyond what a conventional brush would yield, when a brush in accordance with principles of the inventive concept was used. Thus, the yield rate may be enhanced when a brush in accordance with exemplary embodiments of the inventive concept is used.

Additionally, the yield drop rate using a brush in accordance with the principles of the inventive concept was distributed within a range of from about 2% to about 23%. The yield drop rate using a conventional brush was distributed within a range of from about 2% to about 30%. That is, the distribution of the yield drop rate may be reduced when the brush in accordance with exemplary embodiments of the inventive concept is used.

While exemplary embodiments of the inventive concept have been particularly shown and described, it will be understood by one of ordinary skill in the art that variations in form and detail may be made therein without departing from the spirit and scope of the claims.

What is claimed is:

1. A brush for cleaning a substrate, comprising:
a roller body;
a first brush layer covering an outer surface of the roller body; and
a second brush layer on the first brush layer, the second brush layer being thinner than the first brush layer and exhibiting a rate of pore formation lower than that of the first brush layer.

2. The brush of claim 1, wherein the first and second brush layers have protrusions.

3. The brush of claim 2, wherein the first brush layer further includes cylindrical portions between the protrusions, and wherein the second brush layer covers the first brush layer along the protrusions and the cylindrical portions thereof.

4. The brush of claim 2, wherein the protrusions are arranged regularly.

5. The brush of claim 1, wherein the second brush layer includes a plurality of pores, and a rate of pore formation of the second brush layer is from about 10% to about 20%.

6. The brush of claim 1, wherein the second brush layer has a thickness of from about 10 μm to about 20 μm.

7. The brush of claim 1, wherein the first brush layer includes a plurality of pores, and a rate of pore formation of the first brush layer is from about 80% to about 90%.

8. The brush of claim 1, wherein the first and second brush layers include a porous material of polyvinyl acetyl series.

9. The brush of claim 1, wherein the number of the pores of the first brush layer is greater than that of the second brush layer.

10. A scrubber for cleaning a substrate, comprising:
a first rotating roller;
at least one brush coupled to the first rotating roller and making contact with the substrate, the brush including:
a roller body;
a first brush layer covering an outer surface of the roller body; and
a second brush layer on the first brush layer, the second brush layer being thinner than the first brush layer and exhibiting a rate of pore formation lower than that of the first brush layer; and
a second rotating roller for rotating the substrate.

11. The scrubber of claim 10, wherein one brush makes contact with a first surface of the substrate and another brush makes contact with a second surface of the substrate.

12. The scrubber of claim 10, wherein the second brush layer includes a plurality of pores, and a rate of pore formation of the second brush layer is from about 10% to about 20%.

13. The scrubber of claim 10, wherein the second brush layer has a thickness of from about 10 μm to about 20 μm.

14. The scrubber of claim 10, wherein the first brush layer includes a plurality of pores, and a rate of pore formation of the first brush layer is from about 80% to about 90%.

15. The scrubber of claim 10, wherein the first and second brush layers include a porous material of polyvinyl acetyl series.

16. A method of producing a semiconductor device, comprising:
scrubbing a semiconductor wafer with a brush having first and second layers, the second layer being thinner than the first, the second layer having a lower pore density than the first, and the second brush layer contacting the semiconductor wafer during scrubbing.

17. The method of claim 16, further comprising the step of:
planarizing the wafer before scrubbing.

18. The method of claim 16, wherein the step of scrubbing with a brush further includes scrubbing with a brush having a second layer from about about 10 μm to about 20 μm thick

19. The method of claim 16, wherein the step of scrubbing with a brush further includes the step of scrubbing with a brush having a first layer with a pore density of from about 80% to about 90% and a second layer with a pore density of from about 10% to about 20%.

20. The method of claim 16, wherein the step of scrubbing with a brush further includes the step of scrubbing with a brush having first and second brush layers that include a porous material of polyvinyl acetyl series, the layers are generally cylindrical in form and include protrusions from the layers' generally cylindrical surface.
